(19) United States
(12) Patent Application Publication
(10) Pub. No.: US 2020/0126075 A1
(43) Pub. Date: Apr. 23, 2020

(54) CONFIDENTIAL TRANSACTION AUDITING USING AN AUTHENTICATED DATA STRUCTURE

(71) Applicant: Temujin Labs, Inc., Grand Cayman (KY)

(72) Inventor: Benjamin A. Fisch, Menlo Park, CA (US)

(21) Appl. No.: 16/657,891

(22) Filed: Oct. 18, 2019

Related U.S. Application Data
(60) Provisional application No. 62/747,514, filed on Oct. 18, 2018.

(51) Int. Cl. G06Q 20/38; G06Q 40/06; G06Q 20/40; G06F 21/44

(52) U.S. Cl. CPC G06Q 20/38215; G06F 21/44; G06Q 20/401; G06Q 40/06

(57) ABSTRACT

A method initializes an authenticated database and rules that govern transactions. The method provides a multi-signature from validator agents that can approve the transaction and receives a proof that allows the validator agents to validate the transaction is compliant with the rules without revealing a portion of data in the transaction and identities publicly attributable to parties in the transaction. Upon validation of the transaction using a consensus of the set of validator agents, the method updates a state of the authenticated database for the transaction in a sequence of states including prior states from prior transactions. The method provides corresponding transactions and associated proofs for inputs to an audit proof to an auditor entity where the auditor entity validates the corresponding transactions using the associated proofs and inputs the transactions into the proof to validate a statement of the proof.

### CROSS REFERENCE TO RELATED APPLICATIONS

Pursuant to 35 U.S.C. § 119(e), this application is entitled to and claims the benefit of the filing date of U.S. Provisional App. No. 62/747,514 filed Oct. 18, 2018, the content of which is incorporated herein by reference in its entirety for all purposes.

### BACKGROUND

Currently, financial services, such as investment funds, lending platforms, and security exchanges, opaquely handle large amounts of assets, such as trillions of dollars' worth of assets. These may be instances of pooled capital management, where a trusted manager is in charge of a large pool of money contributed by users. The manager uses the initial funds to purchase assets, and also may trade assets that were previously purchased. All these transactions are done on behalf of the financial service (e.g., the investment fund) and are supposed to be executed according to a prespecified mandate. Even though the mandate is specified, the assets may be susceptible to fraud, however. Common cases of fraud include embezzlement, where managers spend funds for illegitimate purposes or steal funds directly, and Ponzi schemes, where managers pay off old investors with the new money contributed to the fund by new investors, giving the false impression that the fund has generated profit.

### BRIEF DESCRIPTION OF THE DRAWINGS

With respect to the discussion to follow and in particular to the drawings, it is stressed that the particulars shown represent examples for purposes of illustrative discussion, and are presented in the cause of providing a description of principles and conceptual aspects of the present disclosure. In this regard, no attempt is made to show implementation details beyond what is needed for a fundamental understanding of the present disclosure. The discussion to follow, in conjunction with the drawings, makes apparent to those of skill in the art how embodiments in accordance with the present disclosure may be practiced. Similar or same reference numbers may be used to identify or otherwise refer to similar or same elements in the various drawings and supporting descriptions. In the accompanying drawings:

FIG. 1 depicts a simplified system of a programmable fund according to some embodiments.

FIG. 2 depicts a simplified flowchart of the initialization process according to some embodiments.

FIG. 3 depicts a simplified flowchart of a method for processing a transaction according to some embodiments.

FIG. 4 depicts a simplified flowchart of a method for verifying transactions in authenticated database according to some embodiments.

FIG. 5 depicts a simplified flowchart of a method for auditing transactions in authenticated database 108 according to some embodiments.

FIG. 6 depicts a simplified flowchart of a method for auditing a statement based on a validity of a proof according to some embodiments.

FIG. 7 depicts processing of a solvency proof according to Category I according to some embodiments.

FIG. 8 depicts a process for the solvency proof in Category II according to some embodiments.

FIG. 9 depicts an example computer system according to some embodiments.

### DETAILED DESCRIPTION

Described herein are techniques for a compliance system. In the following description, for purposes of explanation, numerous examples and specific details are set forth in order to provide a thorough understanding of some embodiments. Some embodiments as defined by the claims may include some or all of the features in these examples alone or in combination with other features described below, and may further include modifications and equivalents of the features and concepts described herein.

Some embodiments perform audits of transactions for capital management. The audits may prevent different types of frauds in different asset management structures, such as pooled asset management (e.g., investment funds). In some embodiments, a system may automatically enforce policies on transactions by the asset manager, without relying on trusted managers and third-party auditing services. The system also preserves the confidentiality of information associated with users and fund managers (such as proprietary capital management strategies) beyond the fact that the fund is compliant with specified policies, and/or the non-existence of certain types of fraud. The system leverages a combination of techniques for confidential transactions on authenticated databases (e.g., distributed ledgers, also referred to as blockchains) and other cryptographic primitives, such as proofs (e.g., zero-knowledge proofs) and secure multi-party computation. The combination verifies transactions and also allows for the automated auditing of the transactions in the authenticated data structure without requiring any third party auditing services.

System Overview

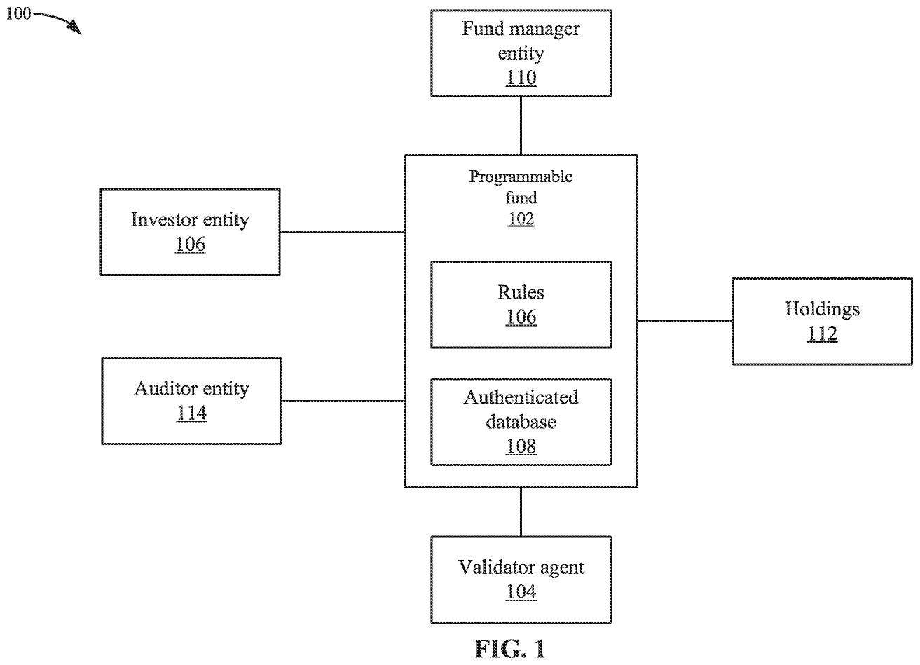

FIG. 1 depicts a simplified system of a programmable fund 102 according to some embodiments. System 100 includes one or more validator agents 104, investor entity 106, fund manager entity 110, and asset issuer entities 108. Although one instance of entities in FIG. 1 are shown, it is recognized that multiple instances may be appreciated. Also, entities depicted in FIG. 1 may be implemented on one or more computing devices, such as servers.

Programmable fund 102 is used to implement an instance of pooled capital management fund. Although not described, programmable fund 102 may be used to implement multiple pooled capital management funds, which may or may not share resources described, such as authenticated database 108. The pooled capital management fund may be run by a fund manager entity 110 that pools capital from investor entities 106. Fund managers are responsible for configuring the initial structure of the fund and raising capital from investors, such as in fiat money or in the form of a digital currency, such as digital ‘fiat’ tokens backed by an issuing bank or a cryptocurrency. These assets are held in secure smart contracts until transparently delivered to the target entity/fund, whether a privately held company, a venture fund, or asset owner seeking capital.

Investor entities 106 are configured to first make capital commitments, assume the liability for uncalled capital, and deliver capital just-in-time when the fund makes a call for an investment. Each capital commitment may be a security token held by fund manager entity 110. In a capital call, the capital commitment security tokens are exchanged for digital fiat tokens sent to the fund account, which are delivered safely to the targets.

Fund manager entity 110 issues legally binding tokens, such as digital tokens (e.g., security tokens), representing fractions of their funds to some or all of investor entities 106. Tokenization enables fund manager entity 110 to provide regulators and investors with audit information, such as proofs of investment balance of record (IBOR), even if the overall holdings are confidential and hidden from the public. This capability is particularly germane to exchanges and money funds, which may hold a diversified class of securities backing investor deposits to maintain a stable Net Asset Value and guaranteed liquidity. Fund manager entity 110 may purchase digitally issued assets 112, which may be any asset that can be purchased using funds of fund manager entity 110.

A digital token is an immutable and transferable representation of value, analogous to a physical token such as a ticket or dollar bill that can be passed from hand to hand. Tokens may be generated, destroyed, or transferred. However, digital tokens are an abstraction, and there are different ways in which they can be represented and transferred digitally. A digital security token is a special kind of digital token that represents a liability and carries meaning under some real world jurisdiction. For example, a token could represent the ability of one counterparty (token holder) to sue the other (token issuer). This is distinct from a digital asset like Bitcoin, which is akin to commodity money (like gold) and has intrinsic value ascribed by the network of its holders.

Digital tokens that represent legal tender, percent ownership of a finite resource, or transferable liabilities such as capital commitment must prevent double spending. If Alice transfers a digital dollar token to Bob, then she cannot transfer the same digital dollar token to Charlie. The double spending problem can be solved by configuring rules 106 appropriately in authenticated database 108. All participants may refer to authenticated database 108 as the “source of truth” regarding the creation, ownership, transfer, and destruction of all digital tokens.

Validator agents 104 may enforce rules 106 of agreement terms between investor entities 106 and fund manager entity 110. Rules 106 may follow a mandate for the pooled capital asset fund. Rules 106 may be abstractly a computer program, e.g. it is written unambiguously as code in an interpretable language, and a hash commitment to the code for this program is stored on authenticated database 108. The metadata of the pooled capital asset fund account specifies the public keys of the custom validator agents 104 and includes the hash commitment to the mandate code on authenticated database 108.

Validator agents 104 store the code for the program implementing rules 106 and are able to execute this code locally. Validator agents 104 can reject a transaction initiated by fund manager entity 110 that does not follow agreed-upon terms. Validator agents 104 can be controlled manually or can be tied to software that interprets rules 106 in programmable fund 102. Validator agents 104 serve as co-signers on transactions between investor entities 106 and fund manager entity 110. This may be implemented through a multi-signature account on the underlying authenticated database 108, such as via a protocol that is managed by the set of validator agents 104.

An address may be a representation of an entity on authenticated database 108, backed by a public-private key pair. The system uses a public key infrastructure (PKI) where validator agents 104, fund manager entities 110, investor entities 106, and asset issuer entities 108 have been assigned certified public keys using some digital signature scheme standard. The private key is stored on the computing device that implements this entity, or alternatively on an external key management device that the computing device may communicate with in order to produce digital signatures.

The address on authenticated database 108 may be derived from the public key, or can be a unique identifier paired with the public-key as an entry on authenticated database 108. The private key is not stored in authenticated database 108. Any software entity that has the private key controls the address. This entity may be operated by an individual or a group, and is used to cryptographically sign and authorize transactions originating from the address. In this way the address may serve as an account. Although the public private key structure is used, other methods of identifying entities may be used.

Any entity might be used by a user that interacts with authenticated database 108. An entity used by a user may control any number of addresses, restricted by relevant policies of authenticated database 108. For instance, auditor entity 114 may control no addresses, but may still access authenticated database 108 and audit the compliance of financial transactions stored in authenticated database 108.

A multi-signature address is an address backed by multiple public-private key pairs. The address may be derived from the public key, or can be a unique identifier paired with the set of public-keys as an entry on authenticated database 108. The database may associate the address with policies. A basic policy is threshold signatures. If a multi-signature account is associated with n public keys, then a threshold policy specifies an integer t<n, which requires all transactions originating from this address to contain a t-of-n threshold multi-signature (TMS). A basic t-of-n TMS is valid if and only if at least t out of the n agents contribute to the signature. More complex TMS validation logic is also possible. A weighted threshold multi-signature assigns a weight to a signature from each agent and requires the weighted sum of signatures to exceed a threshold. More generally, any logical predicate could be used to define signature validity. While the size of most threshold multi-signature signatures scales with the size of the set of agents, certain threshold multi-signature signatures (e.g. based on Boneh-Lynn-Shacham (BLS) signatures) can be made compact even when the set of n agents is large. A TMS policy may apply to specific types of transactions, such as deposit or withdrawal of funds when the address serves as an account. In other instances, multi-signature accounts may be used to require that any transaction affecting an account requires the endorsement by a threshold fraction of specified validator agents 104. This structure provides value above roles that are today handled non-transparently by fund managers, custodians, and administrators.

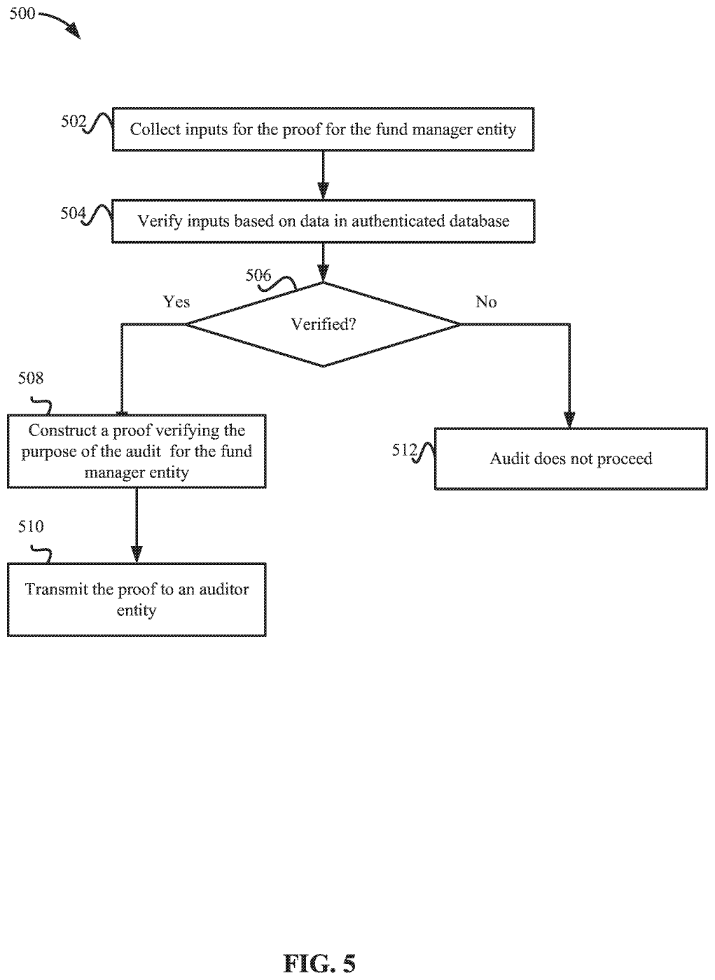

Authenticated database 108 is a transactional state system, such as a system that uses an authenticated data structure to authenticate the data, such as in the following examples: (1) any entity storing the state of the transactional database can deterministically compute a small “fingerprint” data tag that uniquely commits to the database state, (2) any entity that holds a data tag can synchronize with a copy of the transactional database state and verify its authenticity against the data tag, as it is infeasible to forge a data tag such that two distinct versions of the database state verify against this same tag (e.g., new entities joining the network of servers that operate authenticated database 108, or validator agents 104), (3) entities that store only the tag without the database state can still query an entity that stores the database and verify that the query result is correct relative to the unique database consistent with the tag (e.g., investor entity 106, fund manager entity 110, and auditors in FIG. 5, which are not expected to store a complete copy of authenticated database 108), (4) an updated tag can be verified correct given only an update to the database, a tag for the state of the database prior to the update, and a proof associated with the update, enabling entities that are not managing or storing the database to still register committed updates to the tag (e.g., entities such as investor entity 106, fund manager entity 110, and auditor entity 114, that rely on the authenticity and immutability of database 108). The authenticated data structure may also authenticate the historical sequence of database states in addition to the current state (e.g., the data tag commits to both the current database state and the sequence of all prior database states). This makes the database history immutable. Blockchains are special cases of authenticated database 108. Any liability-based asset can be issued in this system described, e.g. a bank can issue a bank-note worth X USD by digitally signing a transaction that creates this note on authenticated database 108.

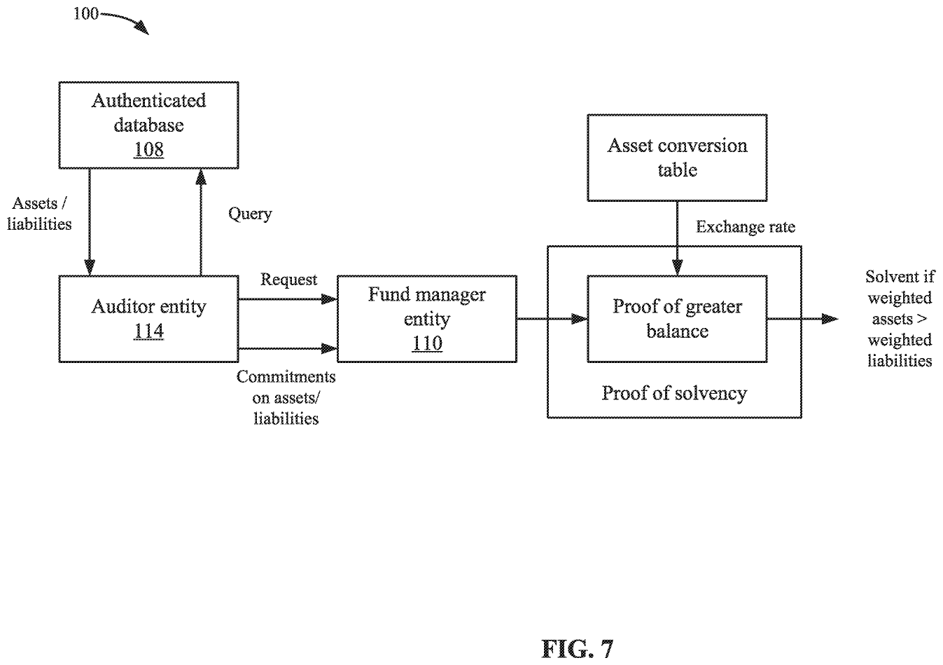

Any server that synchronizes with a copy of authenticated database 108 is called a peer server. In certain embodiments of programmable fund 102, authenticated database 108 may be managed either by a single server or a network of peer servers (e.g., see FIG. 7 for an illustration of a network of peer servers in some embodiments). Peer servers participating in management are called leaders while all other peer servers are called followers. In instances with multiple leaders, the leaders run a consensus protocol to agree on transactions committed to the database, as well as the ordering on transactions. Followers receive transactions committed by the leaders and also run a protocol to ensure a consistent view among peers. These protocols may utilize the authenticated data structure 108, for example, to reduce the required communication of information among peers. In some embodiments, there may not be any differentiation between leaders and followers, such as in unauthenticated (i.e., unpermissioned) consensus protocols. Many cryptocurrencies (e.g., the Bitcoin network) currently run unauthenticated consensus protocols. There may be a prescribed (e.g., permissioned) set of leaders (e.g., specified by public-keys or other form of credentials), a prescribed set of followers, both, or neither. It is further recognized that prescribed sets of leaders or followers may be dynamic. In some embodiments, the set of leaders is permissioned, but followers do not require any special permission to enter the system.

Peer servers that join the network at a later time after transactions may have been committed to authenticated database 108, whether as leaders or followers, synchronize with the database state of authenticated database 108, without trusting other peers, by utilizing the protocol that ensures a consistent view among all peers. As detailed above, peers may not require any special permission to enter the system and can automatically detect in real-time non-compliant transactions approved by deviant validator agents 104. Peers do this by re-running the validator software logic (e.g., of validator agents 104) on approved transactions, and in particular verifying the proofs attached to transaction. In some embodiments, leader peers also act as validator agents 104, or may override validator agents 104 on all transactions or a subset of transactions. Follower peers may not be able to detect censorship or re-ordering of transactions (e.g., selective front-running) before the leader peers commit transactions in a specific order.

The authenticated data structure for authenticated database 108 is abstractly a data structure, comprised of some specified data organization method and storage format (e.g., a set, list, dictionary, tree, graph, etc.), combined with a set of algorithms that enables the following process between two distinct computing processes called a server and a client: (1) the server stores data using the data structure method, (2) the client stores a data tag that is smaller in size than the data stored on the server, (3) each time the server commits a database transaction that modifies data in the data structure (e.g., to add/delete data from a set or modify data at a location in a list) it produces an updated data tag and a proof, (3) the client receives the transaction, updated data tag, and proof, and verifies the proof, (4) the server produces a proof for a claim about a data item and its relation to other data items in the data structure (e.g., proving that a data item is a member of a set, a data item is at a position in a list, a data item is the value associated with a key in a dictionary), (5) the client verifies the proof for a data item and claim. A claim verified by the client is defined as true relative to a sequence of transactions and tag updates verified by the client if and only if it is consistent with the true state of the data structure determined by the sequence of transactions, and otherwise the claim is defined as false. The authenticated data structure is secure if and only if it is infeasible for the server to produce a false claim relative to any sequence of transactions. The servers that store and serve data are not relied upon to enforce policies, and similarly, parties that enforce policies (e.g., validator agents 104) may access the data remotely. Several types of implementation for authenticated database 108 may be used, including various types of Merkle trees, Bloom filters, and cryptographic accumulators.

Authenticated database 108 may use cryptographic commitments that are a cryptographic primitive used to make asset transfers fully confidential. A cryptographic commitment is a scheme that allows one to commit to a chosen value while keeping it hidden to others, with the ability to reveal the value at a later time. Revealing the value is called “opening” the commitment. More precisely, a computing process X outputs a commitment c to some hidden value v and stores a secret hint h; a computing process Y that receives c without h cannot distinguish c from a random value (e.g., learns no information about v from c), but once Y receives v and h it can verify that c is a correct commitment to v. A commitment scheme has two core properties: binding and hiding. The binding property ensures that a commitment can never be opened to two different values (e.g., it is infeasible to produce distinct pairs of h, v that pass verification with the same c). Therefore, if one value was used to create the commitment no other value can later be used to open it. The hiding property ensures that the commitment itself leaks no information about the committed value from authenticated database 108. Several implementations of cryptographic commitments suitable for different settings are provided.

On authenticated database 108, the transactions and identities of investor entities 106 and fund manager entity 110 are kept confidential, but rules 106 governing the behavior of fund manager entity 110 are public. Validator agents 104 and the broader public are able to automatically verify zero-knowledge proofs produced by fund manager entity 110 to ensure that the transactions are compliant with rules and policies, and only compliant and valid transactions are accepted as updates to authenticated database 108. Moreover, regulators and auditors are able to decrypt and inspect certain information about transactions, such as specific amounts within asset transfers.

A zero-knowledge proof system is a cryptographic primitive used to prove the correctness of statements involving both public and private inputs, without revealing the private inputs. More precisely, there is: (1) a computing process called a prover that has a public input x, a private input w called the “witness”, and a dyadic Boolean function R called the “statement” e.g., the output of R on a pair of inputs is either true or false), (2) a computing process called a verifier that has the same public inputs x and statement R, (3) an interactive process (e.g., exchange of messages) between the prover and the verifier that causes verifier to output either an acceptance or a rejection. In a zero-knowledge proof system for R, the prover causes the verifier to output acceptance as long as the output of R on any inputs x and w produced by the prover is true; it is infeasible for the prover to cause the verifier to accept a transaction if the output of R on inputs x and w is false; it is infeasible for verifier to deduce any more information about w than the output of R on inputs x and w. For example, the prover can use a zero-knowledge proof system to convince a verifier that a confidential database transaction transferring assets between two accounts is correct without revealing how many assets were transferred.

The degree of confidentiality in authenticated database 108 is tunable. In one example, basic investor confidentiality (with fund manager visibility) hides the amounts contributed by each investor to the fund from the public (including the other investors) as well as the balances of each of the fund holdings can be achieved just from confidential payments. Only the fund manager is allowed to see all balances. The confidentiality is automatically achieved when the database transactions are confidentially stored in authenticated database 108 using the cryptographic commitments described above.

In another example, full investor confidentiality hides from the fund manager the balances of each investor and reveals only the aggregate can be accomplished with a multi-party computation (MPC) from linear secret sharing. This is a two round protocol where in the first round each investor splits its input into a secret sharing scheme that distributes a secret among a group, such as linear secret shares, one for each investor entity 106. In the second round, investor entities 106 compute an aggregate sum over the shares they have received from other investor entities 106 and publicly post the result of their local computation. The final aggregate sum can be derived from these inputs.

In yet another example, a confidential aggregate balance is provided. In the solution for fully confidential investments based on a secret sharing scheme, the aggregate balance is publicly revealed. In some cases it is desirable that only the fund manager knows how much has been invested overall. This too can be achieved by involving the fund manager in the secret sharing scheme such that only the manager can unmask the final sum. Moreover, if the underlying confidential payment to the contract uses a homomorphic commitment scheme (such as Pedersen commitments) then the MPC can be efficiently modified so that the fund manager is guaranteed to know whether or not the final sum it learns is correct.

Authenticated database 108 may use privacy-preserving proofs, such as zero-knowledge proofs, to prove compliance of transactions with respect to rules 106 of programmable fund 102, while keeping all other information confidential. A zero-knowledge proof may be where a party (e.g., a prover), such as fund manager entity 110, can prove to another party (e.g., verifier), such as auditor 114, that a statement is valid, such as they know a value x, without conveying any information apart from the fact that the statement is valid, such as they know the value x. In some embodiments, these privacy-preserving proofs of compliance may combine zero-knowledge proofs with the proofs used to authenticate information from database 108 (e.g., proofs from the authenticated data structures of authenticated database 108). Users of the system may also use zero-knowledge proofs to respond to audits, generating a publicly-verifiable proof of the audit claim. In a specific example involving a financial use-case, a user may generate a zero-knowledge proof demonstrating possession of funds that exceed a threshold total value without disclosing the specific amount or nature of the funds. General purpose zero-knowledge proof systems that enable generating zero-knowledge proofs for any statement, as well as more efficient bespoke zero-knowledge proof systems that generate proofs for specialized types of statements may be used. The users and various entities interacting with programmable fund 106 may use generic or bespoke zero-knowledge proof systems enabling efficient proofs of compliance for many different types of rules.

It is recognized that there may be more efficient methods for enforcing specific types of rules 106 in a privacy-preserving way that does not require applying generic privacy-preserving proofs to transactions. An example rule, relevant to uses of programmable fund 106 for pooled capital management, is limiting the number of investors that may contribute money to the fund in exchange for fractional ownership of fund profit's (e.g., laws that limit the number of LPs who may participant in a private equity fund in order to qualify for exemptions under the US Investment Company Act of 1940). The validator agents 106 must enforce this policy over confidential transactions, which reveal neither the identities of investors purchasing ownership in the fund nor the amount purchased. A naive method to enforce this policy is to restrict the overall number of transactions that purchase ownership shares of fund to be below the maximum allowable owners. However, this limits each investor to a single transaction and thus inhibits usability. Investors may purchase (or even sell back) shares over the course of multiple transactions. A more sophisticated method that enables this flexibility is to create two types of tokens on authenticated database 108: membership tokens and share tokens. The membership token represents permission to purchase shares of the fund, and share tokens represents actual ownership of fund shares. The programmable fund 106 receives a fixed number of membership tokens (e.g., 100 membership tokens to limit the number of LPs to 100), which were digitally signed by a fund manager entity, and commits them to authenticated database 108. Each membership token has a field naming a specific ownership address, initially set to a default address controlled by the fund manager entity. The fund manager entity may issue digitally signed confidential transactions that transfer ownership of individual membership tokens to other addresses controlled by investor entities. Other transactions may transfer membership tokens among addresses, or from addresses controlled by investor entities back to addresses controlled by the fund manager entity. In this embodiment, rules 106 would enforce that each membership token is transferred from one single address to another, by updating the ownership address field. It is recognized that this may be enforced over confidential addresses. Thus, despite the confidentiality of the system, at any point in time the number of distinct addresses that own membership tokens is below the limit (e.g., 100). As each address may additionally be bound to a unique financial identity (e.g., represented as a digital credential), this limits the total number of distinct entities with distinct financial identities that have permission to purchase shares of the fund. Finally, rules 106 would enforce that each transaction purchasing shares of the fund and assigning ownership of those shares to an address Z must contain a proof (e.g., a zero-knowledge or other privacy-preserving proof) that proves address Z currently owns a membership token. This specialized proof does not require generic zero-knowledge tools, and therefore can be realized more efficiently. For example, if the ownership field of a token is hidden in a Pedersen commitment then this may be implemented as a simple Schnorr proof of knowledge.

System Initiation

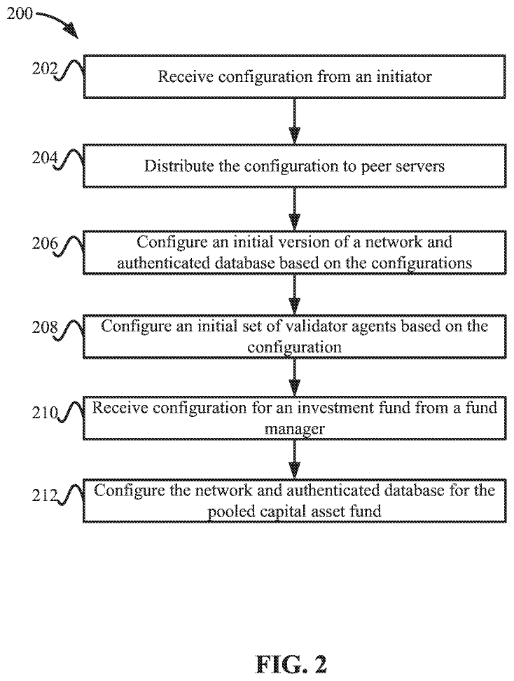

Before performing transactions, programmable fund 102 is initialized. FIG. 2 depicts a simplified flowchart of the initialization process according to some embodiments. At 202, programmable fund 102 receives a configuration from an initiator. The initiator may be any entity or group of entities, such as fund manager entity 110. The initiator may define information for operating programmable fund 102. For example, the initiator may define parameters for authenticated database 108, including but not limited to: a consensus protocol, initial set of validator agents 104, rules 106 (e.g., policies and restrictions) for all transactions, available cryptographic primitives, etc. The initiator also assigns, if applicable, elevated permissions on authenticated database 108 to certain addresses.

At 204, programmable fund 102 distributes the configuration to peer servers. The configuration specifies an initial set of peer servers. At 206, programmable fund 102 configures an initial version of the network and authenticated database 108 based on the received configurations. This opens programmable fund 102 for processing of transactions (e.g., for a pooled capital asset fund that is run by fund manager entity 110). For example, the peer servers receive the configuration and initialize a communication network, initialize authenticated database 108, and commence the consensus protocol to verify and accept transactions on authenticated database 108.

At 208, programmable fund 102 configures an initial set of validator agents 104 based on the configuration. Validator agents 104 may be the same or have overlap with a set of initiators, such as fund manager entity 110, or with the set of peer servers operating authenticated database 108. There may be a fixed or dynamic set of validator agents 104. Some of the rules 106 specify how and when the set of validator agents 104 changes. Rules of this kind are enforced by the peer servers. Other rules are enforced by the validator agents 104. For example, authenticated database 108 could have multiple peer servers and only one fixed validator agent 104, running as a central database, or could have an open set of validator agents 104 (e.g., running as a public decentralized blockchain). There may also be multiple sets of validators agents 104 that enforce different subsets of rules 106 (e.g., pertaining to different instances of pooled capital asset funds implemented by programmable fund 102).

At 210, programmable fund 102 receives a configuration for a pooled capital asset fund from fund manager entity 110. Fund manager entity 110 may define and issue assets on authenticated database 108. Fund manager entity 110 may specify parameters of the asset, such as transferability restrictions and number of units initially available. Also fund manager entity 110 defines and initializes rules 106 for authenticated database 108, such as financial agreements on authenticated database 108. Such agreements may be called smart contracts and are programmatic constructions which are automatically executed and enforced by validator agents 104 when specific conditions are met. Fund manager entity 110 may also specify a new custom set of validator agents 104 that will enforce the subset of rules 106 specific to this pooled capital asset fund, or may otherwise use a default existing set of validator agents 104 that has already been established.

At 212, programmable fund 102 configures the network and authenticated database 108 for the pooled capital asset fund. For example, asset definition, creation, and issuance are transactions on authenticated database 108. Also, the definition and initialization of native smart contracts for the rules is itself a transaction on authenticated database 108.

Transaction Processing

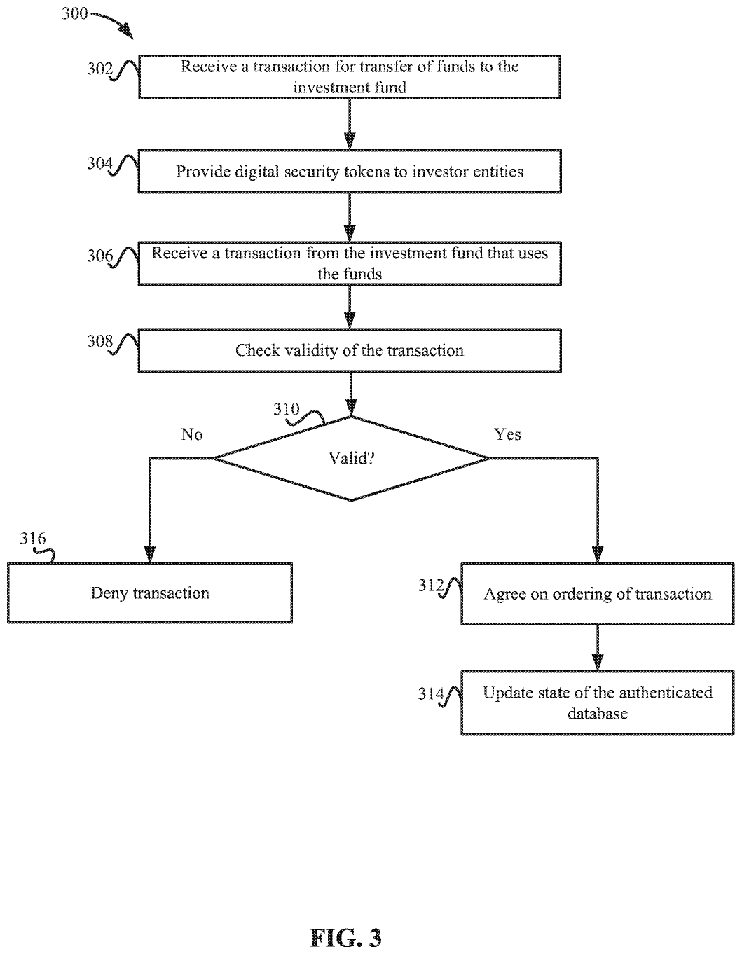

Upon the above initialization, users may perform transactions using programmable fund 102. FIG. 3 depicts a simplified flowchart 300 of a method for processing a transaction according to some embodiments. Validator agents 104 sign their pre-approval if and only if this zero-knowledge proof is valid, but may also leave extra preconditions to be checked by the peer servers at the time the transaction is actually submitted to authenticated database 108 (e.g., the agents may approve it as a standalone transaction, but additional preconditions are required to prevent conflicts between transactions, which cannot be evaluated before the ordering on transactions has been determined). The transaction is submitted to the peer servers operating authenticated database 108 along with the zero-knowledge proof and validator multi-signature. If the multi-signature is valid and the preconditions are met then the transaction will be committed to authenticated database 108 (along with the accompanying zero-knowledge proof and multi-signature).

At 302, programmable fund 102 receives a transaction for a transfer of funds to fund manager entity 110. The transaction includes any number of operations. An asset transfer is one example operation, which specifies an origin address controlled by the user, destination address, asset type, and amount. Additionally, the transaction includes relevant signatures and zero-knowledge proofs that prove the user's ownership of the relevant assets and the user's compliance with respect to the relevant policies. A transaction may be called a “confidential asset transfer” if it contains an asset transfer operation and additionally can be processed and validated without revealing the details of the transaction content to the peer servers and validator agents performing verification. Specific methods for implementing confidential asset transfers were discussed above. Other example operations include operations for defining new asset types, issuing assets to an initial owner address, initializing new policies restricting the transfer of existing assets, or linking addresses to digital credentials.

When fund manager entity 110 executes a transaction from the pooled capital asset fund account, fund manager entity 110 obtains a multi-signature from validator agents 104 that can approve the transaction based on the configuration of the pooled capital asset fund. Fund manager entity 110 provides validator agents 104 with a zero-knowledge proof that a new confidential transaction is compliant with rules 106 without revealing the transaction.

A user for the transaction may be associated with identification information through the issuance of digital credentials and operations linking addresses to credentials. A digital credential may be a list of attributes signed by an authority (or multiple authorities). For example, a specific embodiment is a “financial passport” that aggregates information about a user of an investor entity 106, starting with basic information about the user's accreditation and financial identity, to credit rating/scores, anti-money laundering (AML) whitelisting, etc. All the information in the user's passport would be verified and signed by at least one authority. These signed statements are presented in the form of cryptographic selective disclosure credentials. This means the information is authenticated in such a way that users can selectively reveal components of their identities without unnecessarily compromising the privacy of their entire personal financial profile. Example implementations of selective disclosure credentials combine zero-knowledge proofs with digital signatures, or using cryptographic anonymous credentials where users are given cryptographic tokens which allow them to prove statements about themselves and their relationships with public and private organizations anonymously. Furthermore, users can demonstrate complex statements about their authenticated profile (e.g. an income range, or threshold conjunction of several qualifications) without revealing any precise personal details at all. Digital credentials may involve a public key infrastructure (PKI). There may be a set of root authorities who are able to issue credentials to users and also endorse other sub-authorities with the privilege to issue credentials. Users may then store and manage their own credentials just as they would manage their own cryptographic keys, and they may also elect to share their credentials with a third party custodian, or to store their credentials with a third party.

Programmable fund 102 offers the capability to bind digital credentials to addresses. Furthermore, it does this in a privacy-preserving way so that addresses can be bound to selectively disclosable digital credentials (e.g., an anonymous credential). A registry mapping addresses to digital credentials is stored in authenticated database 108. Some of the digital credentials may be public, otherwise may be completely hidden in the form of a cryptographic token that commits to a set of credentials without revealing them. The programmable fund may receive a special transaction signed by the unique public key of an address to add an entry to the registry binding this address to a credential. In the case that these credentials are implemented using cryptographic anonymous credentials, programmable fund 102 implements the address identity registry in a way that does not compromise the anonymity of selective disclosure. Two possible methods are given. The registry may pair an address with an anonymous credential signature that does not reveal any attributes. This enables the user to selectively reveal attributes of the hidden credential bound to a particular address by producing an anonymous credential signature that selectively reveals attributes combined with a zero-knowledge proof that the anonymous credential signature in the registry (which reveals no attributes) is based on the same cryptographic token. Alternatively, the registry may pair an address with a cryptographic commitment to the anonymous credential token known to the user, enabling the user to provide a zero-knowledge proof that a selective reveal signatures is using the committed hidden token in the registry. Efficient zero-knowledge proofs for both of these statements are possible using sigma protocols. It is recognized that other similar methods may be used, replacing commitments with other types of binding encryption, etc.

In some embodiments, the public-keys of the root authorities are managed on authenticated database 108. Also, there may be several subnetworks that each recognize their own custom list of root credential authorities. For example, one bank may recognize only a first root authority whereas another bank recognizes only a second root authority. This does not outright prevent asset-flow between the two subnetworks, but introduces friction as the users of each subnetwork could be concerned about running afoul of their local security exchange laws. This friction may be resolved through intermediaries or cross endorsements by the respective root authorities. Programmable fund 102 may help facilitate this resolution to ensure that the ecosystem is interconnected.

In response to the transfer of funds, at 304, investor entities 106 may receive digital security tokens representing economic ownership as well as the myriad of complex relationships between investors, fund managers, and companies. For example, a security token may represent fractional ownership of the pooled capital asset fund and the liabilities of the fund participants.

At 306, programmable fund 102 receives a transaction from fund manager entity 110 that uses the funds. In some embodiments, the transaction may be for capital calls, deployment of capital, and return of capital. For example, fund entity manager 110 may purchase some asset using the funds on behalf of investor entity 106. Fund entity manager 110 may interact arbitrarily with existing smart contracts on authenticated database 108. Such transactions contain arbitrary data and instructions, and in most cases will include signatures and zero-knowledge proofs proving compliance with respect to the requirements of rules 106 in authenticated database 108 and the native smart contract. Their validity is determined by the preexisting rules 106 of authenticated database 108 as well as the particular native smart contract. Their impact on authenticated database 108 is a function of the transaction data and the state of the authenticated database 108.

Smart-contracts are dynamic programs driven by transactions on authenticated database 108. The smart-contract state is also stored on authenticated database 108. In particular, smart-contracts can be used to encode complex financial relationships between counterparties with a lifetime spanning more than a single one-time transaction. In essence, smart-contracts define rules that determine how the contract state is affected by transactions on authenticated database 108 and how this state may in turn trigger transactions. For programming smart-contracts, a basic opcode instruction set solves a software consensus problem: contracts written in arbitrary code can lead to ambiguity, and different validator agents 104 may claim different interpretations. A network that is synchronized on a set of basic opcodes serves as a “virtual machine” for programming more complex contracts. This is particularly important in Ethereum where anyone in the network may be a validator. The opcode sets are “Turing complete” if any arbitrary program that can be specified as a Turing machine can also be implemented using the opcode set. However, financial contracts are in general specialized programs that do not come close to requiring a Turing complete language to encode. Furthermore, when a contract is enforced by only a relatively small subset of validator agents 104 then custom software consensus is much more feasible. For example, any custom opcodes need only be distributed to validator agents 104 of smart investment account 102. This enables arbitrary programmable funds 102 over an underlying authenticated database 108 that only supports basic multi-signature escrow contracts.

At 308, validator agents 104 check the validity of the transaction. Transaction validity depends on: (1) rules 106 of authenticated database 108, as defined by the initiator and potentially later modified; (2) the rules of the native smart contract configured for the pooled asset management fund, if the transaction interacts with one. Validator agents 104 running correct software will agree on the validity of individual transactions with respect to the same state.

At 310, validator agents 104 determine if the transaction is valid. Validator agents 104 may execute a consensus protocol amongst each other via the peer-to-peer network to agree on the inclusion and ordering of transactions. Other methods for validating the transaction may also be contemplated. At 312, if validated, validator agents 104 agree on the ordering of the transaction on authenticated database 108. Then, at 314, validator agents 104 update the state of authenticated database 108 based on the effect of the transactions.

If the transaction is not valid, at 316, validator agents 104 deny the transaction. In this case, no information may be written to authenticated database 108 for the transaction. However, in another case, information for the denial of the transaction may be written to authenticated database 108.

Transaction Verification of Transactions in the Authenticated Data Structure

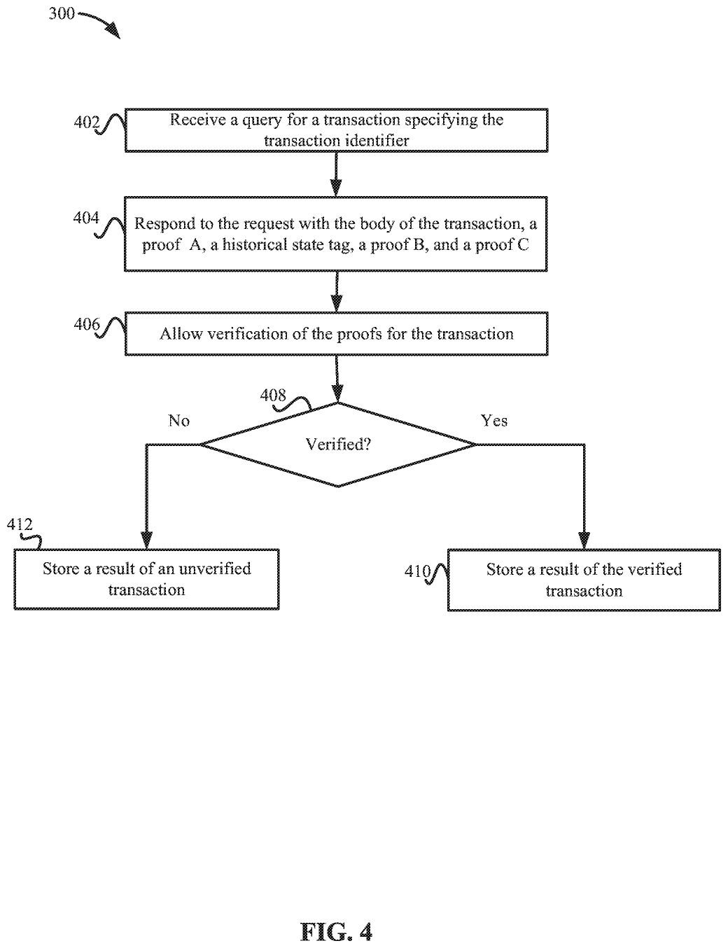

All entities that store a copy of the state of authenticated database 108 may efficiently verify that all transactions on authenticated database 108 are compliant with respect to authenticated database 108 and rules 106. In addition, entities (e.g., peer servers) that store a copy of the state of authenticated database 108 may receive queries from outside entities (e.g., clients such as investor entity 106 or fund manager entity 110) to view transactions or verify their authenticity, and respond with proofs that enable the outside entities to verify both the authenticity of the queried transactions and their compliance with rules 106. This enables an entity in the network to detect non-compliant transactions in authenticated database 108 at any time. FIG. 4 depicts a simplified flowchart 400 of a method for verifying transactions in authenticated database 108 according to some embodiments.

At 402, programmable fund 102 receives a query for a transaction specifying the transaction identifier (e.g., a unique reference to the location of the transaction in the transaction log). The query is processed by at least one peer server that has stored the requested transaction. In certain implementations, the storage may be load balanced among peer servers, and any standard method might be used to locate a server that is storing the relevant transaction and all proofs attached to it. Once the query has been received by the appropriate peer server, at 404, the server responds to the request with the body of the transaction, a proof (Proof A) from authenticated database 108 that proves this is the authentic transaction requested, the historical state tag for the database at the time the transaction was committed, a proof (Proof B) from authenticated database 108 that proves the historical state tag is authentic, and finally, a proof (Proof C) attached to the transaction that authenticates other information from authenticated database 108 that is referenced by the transaction. In some embodiments, authenticated data structures for Proofs A and B, the current state tag of authenticated database 108 would commit to the historical log of transactions using an authenticated array (e.g., a Merkle tree) as well as the historical log of state tags using a separate authenticated array. The query and response may be implemented over a network in any number of standard ways.

At 406, programmable fund 102 allows verification of the various proofs A, B, and C by running the verification algorithms of the respective authenticated data structures. For example, if the data structure for Proof C is an authenticated dictionary implemented with a sparse Merkle tree, then the proof includes a collection of Merkle paths (e.g., paths from leaves to the root and the hash values on all siblings of nodes along each path); it is verified by reconstructing the hash values on nodes along each path and comparing the reconstructed root to the correct root. The body of the transaction may also contain signatures, multi-signatures, and other proofs, such as zero-knowledge proofs. These are all verified by entity that receives and processes the transaction query response. The entity runs the verification algorithms of the digital signatures, multi-signatures, and zero-knowledge proofs. At 408, the entity that issued the transaction query within programmable fund 102 determines if the proofs returned along with the transaction passed verification. If so, at 410, the entity stores a result of the verified transaction. If not, at 412, the entity stores a result of an unverified transaction.

Auditing of the Authenticated Data Structure

Fund entity manager 110 may, at any time, produce an arbitrary proof with respect to the state of authenticated database 108. For instance, fund entity manager 110 can construct a zero-knowledge proof of solvency for some particular scenario and transmit the proof data to investors, regulators, and other users. The receiving users may check the validity of the proof against the data in authenticated database 108.

FIG. 5 depicts a simplified flowchart 500 of a method for auditing transactions in authenticated database 108 according to some embodiments. At some time, fund manager entity 110 may publish a proof, such as zero-knowledge proofs of some statement related to the state of authenticated database 108. The proof keeps identities of users and other information confidential while allowing for the statement to be verified. At 502, fund manager entity 110 collects inputs for a proof to audit transactions. At 504, fund manager entity 110 verifies the inputs based on data from authenticated database 108. At 506, fund manager entity 110 determines if the inputs were verified. If so, at 508, the fund manager entity 110 constructs a proof that demonstrates the purpose of the audit. At 510, fund manager entity 110 transmits the proof to an auditor entity 114 that can verify the proof. If not, then at 512, the audit does not proceed as the inputs were not verified.

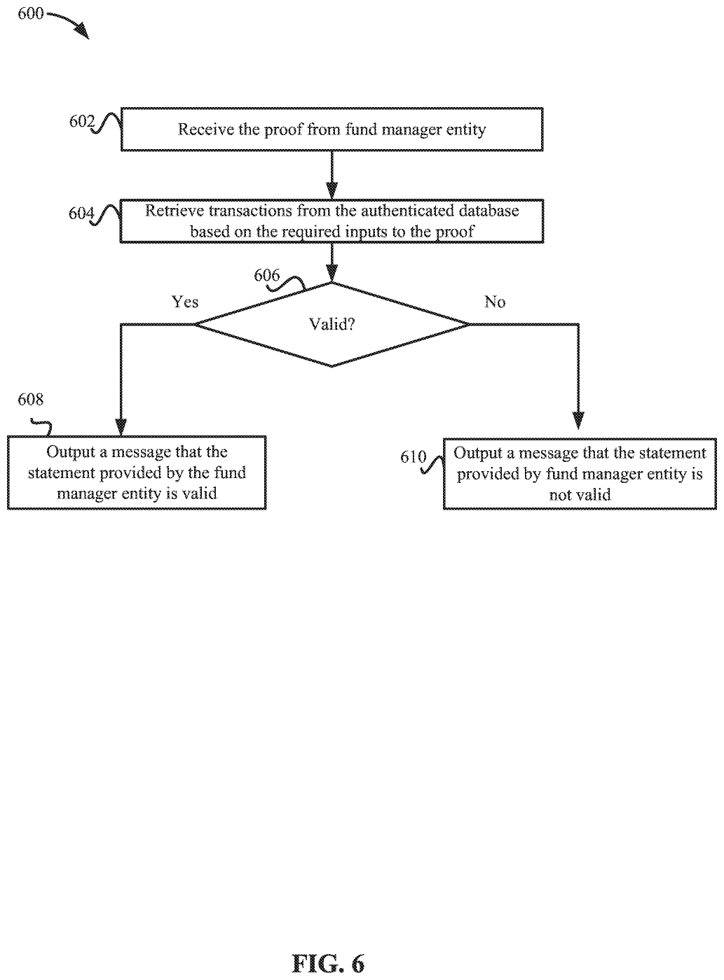

FIG. 6 depicts a simplified flowchart 600 of a method for auditing a statement based on a validity of a proof according to some embodiments. At 602, auditor entity 114 (e.g., computing device) receives the proof from fund manager entity 110. At 604, the auditor entity retrieves transactions from authenticated database 108 based on the required inputs to the proof. At 606, the auditor entity checks the validity of the proof.

If the validity of the proof is valid, at 608, auditor entity 114 outputs a message that the statement provided by fund manager entity 110 is valid. If the validity of the proof is not valid, at 610, auditor entity 114 outputs a message that the statement provided by fund manager entity 110 is not valid.

As discussed above, traditionally, auditing of financial institutions relies on trusting a third party auditor to perform the audit, which requires the auditor to access the data for transactions and possibly the identities of the parties involved. However, programmable fund 102 allows the auditor entity to perform an audit by verifying an audit proof without having access to a value for the transactions that is subject to the proof of validity. Further, the auditing may be performed automatically and dynamically as transactions are added to authenticated database 108. Because validation of the proof is automated, fraud may be detected as it is happening rather than having to wait for a human user to perform the audit at a later time conventionally.

Different proofs may be used to audit for compliance. For example, a proof of solvency for an entity on authenticated database 108 demonstrates that the value of assets controlled by the entity exceeds its liabilities. This enables the entity to demonstrate solvency even when the assets and liabilities recorded on authenticated database 108 are confidential. A proof of solvency may be applied in many different use cases. Other types of proofs include proofs of liquidity, proof of correct fee, proof of whitelisted asset, proof of non-blacklisted asset, and selective disclosure of an identity bound to an address.

Constructing a proof of solvency requires as input the set of confidential accounts or transactions that are the source of information on the entity's assets and liabilities under consideration. When assets/liabilities of different types are included, then another necessary input is a conversion rate to equate asset/liability token units of different types. After the inputs are collected, the auditor verifies the inputs using the data authenticated database 108, and the entity constructs a zero-knowledge proof proving that the weighted sum of input assets exceed the weighted sum of input liabilities. The protocol for a proof of solvency is broken into three general steps. For the purpose of the description, auditor refers to the auditing entity, which receives and processes proofs from another entity referred to as Asset Owner (e.g., the fund manager entity). Two categories of solvency proofs are described, labeled Category I and Category II respectively. FIG. 7 depicts processing of a solvency proof according to Category I according to some embodiments.

The Auditor process for a solvency proof of Category I is as follows. The first step is an input collection step. The Auditor first receives inputs specifying transactions in the historical log of authenticated database 108 and/or components of the current state of authenticated database 108 (e.g., the state of accounts in the database). Based on these inputs, the Auditor issues a query to retrieve the relevant information from authenticated database 108 (e.g., a local query if Auditor stores a copy of the database, or to an external entity such as a peer server). In the case that the Auditor issues queries to an external entity storing a copy of the database, it verifies any proofs attached to the results from the authenticated data structure, as detailed above under transaction verification. Collectively, the inputs the Auditor has gathered are organized into two sets of “assets”: an asset set and a liability set. In various implementations, the assets may take different forms (e.g., a record of ownership or a balance within an account), but all follow the abstract template of specifying an address, an asset type, and an amount. For example, in some embodiments the asset set could be a collection of assets and balances in the account of an investment fund, while the liability set could be all transactions transferring money (e.g., digital fiat money) from investors to the fund. The Auditor also receives as input a Conversion Rate Table (CRT), which converts the value of all asset types in the asset set and liability set to a common unit. The solvency proof will demonstrate that the total value of the asset set (converted to the common unit) exceeds the total value of the sum of assets in the liability set (converted to the common unit), according to the CRT. If the assets are not confidential then the Auditor performs this check directly. In the more complex scenario that the assets are confidential, either encrypted or hidden in some form, such as with Pedersen commitments, then the Auditor additionally receives a proof of greater total balance with weights from the Asset Owner. For example, this may be a zero-knowledge proof showing that the weighted sum of input assets exceeds the weighted sum of input liabilities. In an implementation of confidential assets using Pedersen commitments, efficient constructions of this zero-knowledge proof may be used, for example, combining Sigma proofs and range proofs (e.g., using Bulletproofs).

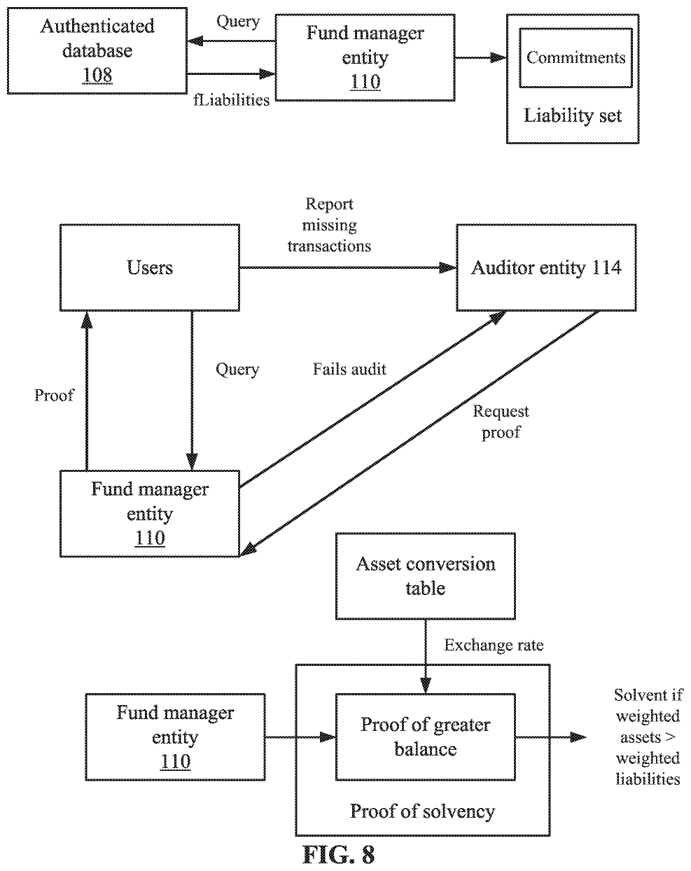

The Auditor process for a solvency proof of Category II is a modification of the process for Category I. FIG. 8 depicts a process for the solvency proof in Category II according to some embodiments. In this case, the Auditor receives the asset set and liability set from the Asset Owner, and performs the following verification steps. Depending on the specific audit input, the Auditor may also request and receive additional proofs from the Asset Owner, such as a proof that some asset type from the claimed liability set is a recognized liability token (e.g., proof of whitelisted asset) or a credential proof that the target address in a transaction is registered to a recognized user type (e.g., an investor entity or corporate entity). The auditor may also request and receive inputs from other entities, such as investor entity 106, or other user entities that interact with Asset Owner. For example, in some embodiments the LPs of an investment fund would check that the fund's liabilities to them are accounted for in the liability set. An example of how this process would be implemented is explained next.

In some cases, the Auditor initiates a process that requires other user entities to verify that specific information, such as transactions or accounts, were included in the liability set. This may force the users to identify their accounts and addresses to the auditors. The following protocol enables this process to be executed in an anonymity-preserving way. The protocol assumes each user entity u has a public key uPK. The Asset Owner first gathers all the original inputs in the liability set and does not send them to the Auditor directly. The Asset Owner places the liability set in an authenticated data structure (e.g., a Merkle tree), and sends the state tag T1 (e.g., Merkle root) of the authenticated data structure to the Auditor. The Asset Owner generates a second version of the liability set by randomizing the ciphertexts or cryptographic commitments of the first (e.g., if the first set of asset tuples is hidden via Pedersen commitments, then the second set replaces each Pedersen commitment with a fresh Pedersen commitment to the same values). The Asset Owner places this second set in an authenticated data structure and sends the state tag T2 to the Auditor. Finally, for each asset tuple ciphertext/commitment to be checked by user entity u with public key uPK, the Asset Owner creates a set-membership authentication proof (e.g., proof of inclusion in the Merkle tree) relative to T1, a set-membership authentication proof for the randomization of this asset tuple ciphertext/commitment relative to T2, and a proof that the randomized asset tuple ciphertext/commitment is a randomization of the first (e.g., that it encrypts/hides the same content). The proof may be implemented as a zero-knowledge proof of knowledge. This collection of proofs is encrypted under uPK; the encryption is denoted uProofs. The Asset Owner sends triples of (uProofs, uPK, uAssets) to the Auditor where uAssets is the set of randomized asset ciphertext/commitments to be checked by user u. The Auditor receives state tags T1 and T2. The Auditor receives a table of triples (uProofs, uPK, uAssets). The Auditor broadcasts or publishes the table of triples along with T1 and T2. The Auditor waits to receive responses from users. Each user u with public key uPK now has the opportunity to decrypt uProofs and verify them against T1 and T2, using the algorithms from the specific authenticated data structure employed by the specific implementation of this protocol. In addition, the Auditor receives a proof of greater total balance with weights from the Asset Owner, comparing the “randomized” liability set aggregated by T2 to the asset set. The randomized liability set does not reveal links between users and transactions or specific accounts in authenticated database 108. Once the Auditor receives responses from users (e.g., approval/complaints) and verifies the proof of greater total balance, it outputs its final report.

A proof of whitelisted asset is a proof that a confidential asset type is on a whitelist of approved assets. Such proofs use cryptographic accumulators and zero-knowledge proofs. The entity creating the proof uses as input the public record of the asset transfer transactions, the private keys or other types of blinding factors associated with the confidential asset transfer, and a public whitelist of approved asset types. Verifying the proof requires querying authenticated database 108 to obtain the public record of the asset transfer transaction and also the public whitelist of approved asset types.

Embezzlement may be effectively prevented by including whitelists of addresses in the mandate. There are generally multiple classes of transactions from a pooled capital asset account and each transaction has a type label. For instance, transactions paying a dividend to an investor entity 106 is labeled differently from a transaction that purchases an asset for the fund's portfolio. Each transaction type has associated rules it must comply with, which may include an associated whitelist of addresses. For example, there could be a whitelist of addresses for asset purchases, and this enforces that every transaction labeled as an asset purchase must be directed to an address from this list (e.g., addresses of approved asset issuers of S&P 500 stocks). The zero-knowledge proof does not reveal the destination address of the asset purchase, only that it is a member of this whitelist. The zero-knowledge proof may be implemented as a zero-knowledge membership proof in an authenticated data structure for the whitelist. For example, the whitelist may be placed in a Merkle tree, in which case the zero-knowledge proof is for a statement R(x, w) where x is the Merkle tree root and hidden asset tuple (e.g., Pedersen commitment to the asset type taken from the transaction), w is the asset type combined with a Merkle path authenticating the asset type as a leaf of the Merkle tree and other information required to open the commitment (e.g., a blinding factor), and R checks that the hidden asset type correctly corresponds to the asset type in w and that the Merkle path is valid. A fund manager might attempt to circumvent the whitelist and execute an illegitimate asset purchase by mislabeling the transaction as something else (e.g. a dividend payment). Programmable fund 102 prevents this transaction by appropriately specifying the policies for each transaction type: a dividend payment must satisfy the dividend policy, and therefore qualifies as a legitimate dividend payment, not a disguised asset purchase.

Programmable fund 102 uses blacklists to prevent undesired activity, such as Ponzi scheme prevention. The addresses of all investor entities 106 in the pooled capital asset fund are included in a blacklist, maintained as an authenticated data structure supporting non-inclusion proofs, such as a sorted Merkle tree or other type of universal cryptographic accumulator. In the case of using a sorted Merkle tree, the root is stored on authenticated database 108. This root is updated every time a new investor joins the fund. The Merkle tree root does not leak the addresses of investors to the public. Investors may request proof from the fund that they are included in the Merkle tree root (i.e., included in the blacklist). Before the fund makes a dividend payment, investors/auditors may request a proof regarding the solvency of the fund, specifically the value of its assets that come from sources not on the blacklist.

Programmable fund 102 uses traceable group signatures for audit tracking of users without publicly compromising user privacy. Auditors may manage a database of user identity data and issue registration tags to users who register in this database. Users attach registration proofs to transactions by signing the transaction with their group secret keys, creating a traceable group signature on the transaction. While the traceable group signature is anonymous to most public viewers, auditors can trace these signatures back to the registered user and locate the user's identity data in their database.

Confidential asset tracers are used by asset issuers and regulators to track the details of transactions that are otherwise hidden to other users. The confidential asset tracers encrypt the private details of transactions under public keys known to the asset issuer or regulator, and a privacy-preserving compliance proof is required to demonstrate to validator agents 104 that the transaction is valid.

The system uses traceable group signatures for audit tracking of users without publicly compromising user privacy. Auditors may manage a database of user identity data and issue registration tags to users who register in this database. Users attach registration proofs to transactions by signing the transaction with their group secret keys, creating a traceable group signature on the transaction. While the traceable group signature is anonymous to most public viewers, auditors can trace these signatures back to the registered user and locate the user's identity data in their database.

### Example Embodiments

In some embodiments, a method comprising: initializing, by a computing system, an authenticated database and rules that govern transactions for a pooled capital management fund on behalf of investor entities, wherein the authenticated database includes data structures storing data that is authenticated; for a transaction using funds in the pooled capital management fund, providing, by the computing system, a multi-signature from a set of validator agents that can approve the transaction; receiving, by the computing system, a proof that allows the set of validator agents to validate the transaction is compliant with the rules without revealing a portion of data in the transaction and identities publicly attributable to parties in the transaction; upon validation of the transaction using a consensus of the set of validator agents, updating, by the computing system, a state of the authenticated database for the transaction in a sequence of states including prior states from prior transactions, wherein information for each transaction that is stored in the authenticated database is associated with a proof that is useable to validate the transaction and a multi-signature of the set of validator agents that validated the transaction; and providing, by the computing system, corresponding transactions and associated proofs for inputs to an audit proof to an auditor entity, wherein the auditor entity validates the corresponding transactions using the associated proofs and inputs the transactions into the proof to validate a statement of the proof without revealing content of the transactions that prove the statement demonstrating the validity of the audit of the statement of the pooled capital management fund.

In some embodiments, the set of validator agents validates the transaction without knowledge of the portion of data in the transaction.

In some embodiments, the set of validator agents use a consensus protocol to validate the transaction.

In some embodiments, the method further comprising: receiving an investment of funds into the pooled capital management fund, wherein the purchase is recorded in a transaction on the authenticated data structure.

In some embodiments, the method further comprising: providing digital security tokens to one or more investor entities for the investment of funds.

In some embodiments, the method further comprising: receiving a purchase of an asset from the pooled capital management fund, wherein the purchase is recorded in the transaction on the authenticated data structure.

In some embodiments, storing the transaction in the authenticated data structure comprises: storing the transaction in an order that is agreed upon by the set of validator agents.

In some embodiments, the method further comprising: providing transactions from the authenticated database to a peer, wherein the peer validates respective transactions in the authenticated database using the proofs and the multi-signatures associated with each of the respective transactions.

In some embodiments, a state of the transactions in the authenticated database compute to a data tag, and the data tag is usable to authenticate the state of the transactions in the authenticated database.

In some embodiments, an updated data tag is verifiably correct given an update to the state of the authenticated database using a tag for the state of the database prior to the update and a proof associated with the update.

In some embodiments, the inputs comprise an asset set for an account of the pooled capital management fund and a liability set comprises transactions transferring money from investor entities to the pooled capital management fund, and the audit proof proves the statement that a total value of the asset set exceeds a total value of a sum of assets in the liability set without knowing an identity of the assets.

In some embodiments, the auditor entity receives proofs for the corresponding transactions and uses the proofs to verify content of the transactions without knowing the content of the transactions.

In some embodiments, a non-transitory computer-readable storage medium having stored thereon computer executable instructions, which when executed by a computing system, cause the computing device to be operable for: initializing an authenticated database and rules that govern transactions for a pooled capital management fund on behalf of investor entities, wherein the authenticated database includes data structures storing data that is authenticated; for a transaction using funds in the pooled capital management fund, providing a multi-signature from a set of validator agents that can approve the transaction; receiving a proof that allows the set of validator agents to validate the transaction is compliant with the rules without revealing a portion of data in the transaction and identities publicly attributable to parties in the transaction; upon validation of the transaction using a consensus of the set of validator agents, updating a state of the authenticated database for the transaction in a sequence of states including prior states from prior transactions, wherein information for each transaction that is stored in the authenticated database is associated with a proof that is useable to validate the transaction and a multi-signature of the set of validator agents that validated the transaction; and providing corresponding transactions and associated proofs for inputs to an audit proof to an auditor entity, wherein the auditor entity validates the corresponding transactions using the associated proofs and inputs the transactions into the proof to validate a statement of the proof without revealing content of the transactions that prove the statement demonstrating the validity of the audit of the statement of the pooled capital management fund.

In some embodiments, the instructions are further operable for: providing transactions from the authenticated database to a peer, wherein the peer validates respective transactions in the authenticated database using the proofs and the multi-signatures associated with each of the respective transactions.

In some embodiments, the inputs comprise an asset set for an account of the pooled capital management fund and a liability set comprises transactions transferring money from investor entities to the pooled capital management fund, and the audit proof proves the statement that a total value of the asset set exceeds a total value of a sum of assets in the liability set without knowing an identity of the assets.

In some embodiments, the auditor entity receives proofs for the corresponding transactions and uses the proofs to verify content of the transactions without knowing the content of the transactions.

In some embodiments, a method comprising: receiving, by a computing device, inputs specifying transactions in a historical log of an authenticated database, wherein the authenticated database includes data structures storing data that is authenticated; sending, by the computing device, one or more queries to retrieve the transactions for the inputs from the authenticated database, wherein the transactions are stored with associated proofs validate the associated transaction is compliant with rules without revealing a portion of data in the transaction; validating, by the computing device, the transactions using the associated proofs for the transactions without having access to the portion of data in the transaction; converting, by the computing device, the inputs into a first set of inputs and a second set of inputs based on a first set of characteristics for the first set of inputs and a second set of characteristics for the second set of inputs; and applying, by the computing device, an audit proof validating a statement comparing a computation based on the first set of inputs and the second set of inputs, wherein data in the computation being validated by the audit proof is confidential and a statement proof is used to validate the data that is confidential is valid.

In some embodiments, the first set of inputs comprises an asset set comprises a collection of assets and balances in an account of an investment fund and the second set of inputs comprises a liability set comprising transactions transferring money from investors to the investment fund.

In some embodiments, the statement comprises a total value of a sum of the asset set exceeds a total value of a sum of the liability set.

In some embodiments, the statement proof demonstrates the total value of the sum of the assets exceeds the total value of the sum of the liability set.

System

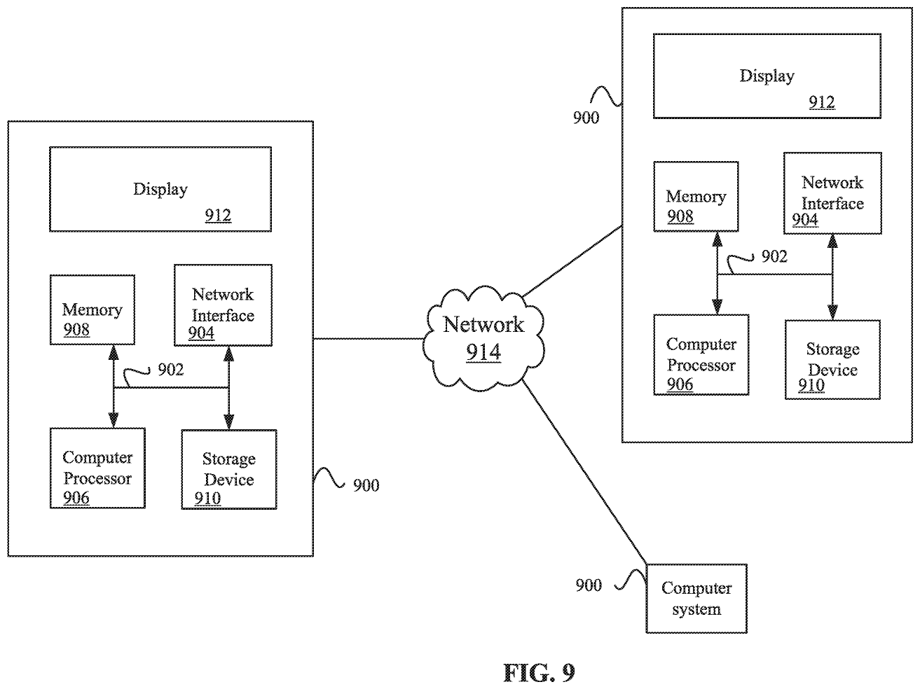

FIG. 9 illustrates an example of special purpose computer systems 900 according to one embodiment. Computer system 900 includes a bus 902, network interface 904, a computer processor 906, a memory 908, a storage device 910, and a display 912.

Bus 902 may be a communication mechanism for communicating information. Computer processor 906 may execute computer programs stored in memory 908 or storage device 908. Any suitable programming language can be used to implement the routines of some embodiments including C, C++, Java, assembly language, etc. Different programming techniques can be employed such as procedural or object oriented. The routines can execute on a single computer system 900 or multiple computer systems 900. Further, multiple computer processors 906 may be used.

Memory 908 may store instructions, such as source code or binary code, for performing the techniques described above. Memory 908 may also be used for storing variables or other intermediate information during execution of instructions to be executed by processor 906. Examples of memory 908 include random access memory (RAM), read only memory (ROM), or both.

Storage device 910 may also store instructions, such as source code or binary code, for performing the techniques described above. Storage device 910 may additionally store data used and manipulated by computer processor 906. For example, storage device 910 may be a database that is accessed by computer system 900. Other examples of storage device 910 include random access memory (RAM), read only memory (ROM), a hard drive, a magnetic disk, an optical disk, a CD-ROM, a DVD, a flash memory, a USB memory card, or any other medium from which a computer can read.

Memory 908 or storage device 910 may be an example of a non-transitory computer-readable storage medium for use by or in connection with computer system 900. The non-transitory computer-readable storage medium contains instructions for controlling a computer system 900 to be configured to perform functions described by some embodiments. The instructions, when executed by one or more computer processors 906, may be configured to perform that which is described in some embodiments.

Computer system 900 includes a display 912 for displaying information to a computer user. Display 912 may display a user interface used by a user to interact with computer system 900.

Computer system 900 also includes a network interface 904 to provide data communication connection over a network, such as a local area network (LAN) or wide area network (WAN). Wireless networks may also be used. In any such implementation, network interface 904 sends and receives electrical, electromagnetic, or optical signals that carry digital data streams representing various types of information.

Computer system 900 can send and receive information through network interface 904 across a network 914, which may be an Intranet or the Internet. Computer system 900 may interact with other computer systems 900 through network 914. In some examples, client-server communications occur through network 914. Also, implementations of some embodiments may be distributed across computer systems 900 through network 914.

Some embodiments may be implemented in a non-transitory computer-readable storage medium for use by or in connection with the instruction execution system, apparatus, system, or machine. The computer-readable storage medium contains instructions for controlling a computer system to perform a method described by some embodiments. The computer system may include one or more computing devices. The instructions, when executed by one or more computer processors, may be configured to perform that which is described in some embodiments.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of some embodiments may be implemented. The above examples and embodiments should not be deemed to be the only embodiments, and are presented to illustrate the flexibility and advantages of some embodiments as defined by the following claims. Based on the above disclosure and the following claims, other arrangements, embodiments, implementations and equivalents may be employed without departing from the scope hereof as defined by the claims.

What is claimed is:

1. A method comprising:
initializing, by a computing system, an authenticated database and rules that govern transactions for a pooled capital management fund on behalf of investor entities, wherein the authenticated database includes data structures storing data that is authenticated;
for a transaction using funds in the pooled capital management fund, providing, by the computing system, a multi-signature from a set of validator agents that can approve the transaction;
receiving, by the computing system, a proof that allows the set of validator agents to validate the transaction is compliant with the rules without revealing a portion of data in the transaction and identities publicly attributable to parties in the transaction;
upon validation of the transaction using a consensus of the set of validator agents, updating, by the computing system, a state of the authenticated database for the transaction in a sequence of states including prior states from prior transactions, wherein information for each transaction that is stored in the authenticated database is associated with a proof that is useable to validate the transaction and a multi-signature of the set of validator agents that validated the transaction; and
providing, by the computing system, corresponding transactions and associated proofs for inputs to an audit proof to an auditor entity, wherein the auditor entity validates the corresponding transactions using the associated proofs and inputs the transactions into the proof to validate a statement of the proof without revealing content of the transactions that prove the statement demonstrating the validity of the audit of the statement of the pooled capital management fund.

2. The method of claim 1, wherein the set of validator agents validates the transaction without knowledge of the portion of data in the transaction.

3. The method of claim 1, wherein the set of validator agents use a consensus protocol to validate the transaction.

4. The method of claim 1, further comprising:
receiving an investment of funds into the pooled capital management fund, wherein the purchase is recorded in a transaction on the authenticated data structure.

5. The method of claim 4, further comprising:
providing digital security tokens to one or more investor entities for the investment of funds.

6. The method of claim 1, further comprising:
receiving a purchase of an asset from the pooled capital management fund, wherein the purchase is recorded in the transaction on the authenticated data structure.

7. The method of claim 1, wherein storing the transaction in the authenticated data structure comprises:
storing the transaction in an order that is agreed upon by the set of validator agents.

8. The method of claim 1, further comprising:
providing transactions from the authenticated database to a peer, wherein the peer validates respective transactions in the authenticated database using the proofs and the multi-signatures associated with each of the respective transactions.

9. The method of claim 1, wherein:
a state of the transactions in the authenticated database compute to a data tag, and
the data tag is usable to authenticate the state of the transactions in the authenticated database.

10. The method of claim 9, wherein:
an updated data tag is verifiably correct given an update to the state of the authenticated database using a tag for the state of the database prior to the update and a proof associated with the update.

11. The method of claim 1, wherein:
the inputs comprise an asset set for an account of the pooled capital management fund and a liability set comprises transactions transferring money from investor entities to the pooled capital management fund, and
the audit proof proves the statement that a total value of the asset set exceeds a total value of a sum of assets in the liability set without knowing an identity of the assets.

12. The method of claim 1, wherein:
the auditor entity receives proofs for the corresponding transactions and uses the proofs to verify content of the transactions without knowing the content of the transactions.

13. A non-transitory computer-readable storage medium having stored thereon computer executable instructions, which when executed by a computing system, cause the computing device to be operable for:
initializing an authenticated database and rules that govern transactions for a pooled capital management fund on behalf of investor entities, wherein the authenticated database includes data structures storing data that is authenticated;
for a transaction using funds in the pooled capital management fund, providing a multi-signature from a set of validator agents that can approve the transaction;
receiving a proof that allows the set of validator agents to validate the transaction is compliant with the rules without revealing a portion of data in the transaction and identities publicly attributable to parties in the transaction;
upon validation of the transaction using a consensus of the set of validator agents, updating a state of the authenticated database for the transaction in a sequence of states including prior states from prior transactions, wherein information for each transaction that is stored in the authenticated database is associated with a proof that is useable to validate the transaction and a multi-signature of the set of validator agents that validated the transaction; and
providing corresponding transactions and associated proofs for inputs to an audit proof to an auditor entity, wherein the auditor entity validates the corresponding transactions using the associated proofs and inputs the transactions into the proof to validate a statement of the proof without revealing content of the transactions that prove the statement demonstrating the validity of the audit of the statement of the pooled capital management fund.

14. The non-transitory computer-readable storage medium of claim 15, further operable for:
providing transactions from the authenticated database to a peer, wherein the peer validates respective transactions in the authenticated database using the proofs and the multi-signatures associated with each of the respective transactions.

15. The non-transitory computer-readable storage medium of claim 15, wherein:
the inputs comprise an asset set for an account of the pooled capital management fund and a liability set comprises transactions transferring money from investor entities to the pooled capital management fund, and
the audit proof proves the statement that a total value of the asset set exceeds a total value of a sum of assets in the liability set without knowing an identity of the assets.

16. The non-transitory computer-readable storage medium of claim 15, wherein:
the auditor entity receives proofs for the corresponding transactions and uses the proofs to verify content of the transactions without knowing the content of the transactions.

17. A method comprising:
receiving, by a computing device, inputs specifying transactions in a historical log of an authenticated database, wherein the authenticated database includes data structures storing data that is authenticated;
sending, by the computing device, one or more queries to retrieve the transactions for the inputs from the authenticated database, wherein the transactions are stored with associated proofs validate the associated transaction is compliant with rules without revealing a portion of data in the transaction;
validating, by the computing device, the transactions using the associated proofs for the transactions without having access to the portion of data in the transaction;
converting, by the computing device, the inputs into a first set of inputs and a second set of inputs based on a first set of characteristics for the first set of inputs and a second set of characteristics for the second set of inputs; and
applying, by the computing device, an audit proof validating a statement comparing a computation based on the first set of inputs and the second set of inputs, wherein data in the computation being validated by the audit proof is confidential and a statement proof is used to validate the data that is confidential is valid.

18. The method of claim 18, wherein the first set of inputs comprises an asset set comprises a collection of assets and balances in an account of an investment fund and the second set of inputs comprises a liability set comprising transactions transferring money from investors to the investment fund.

19. The method of claim 18, wherein the statement comprises a total value of a sum of the asset set exceeds a total value of a sum of the liability set.

20. The method of claim 19, wherein the statement proof demonstrates the total value of the sum of the assets exceeds the total value of the sum of the liability set.
